(19) United States
(12) Patent Application Publication
(10) Pub. No.: US 2006/0144286 A1
(43) Pub. Date: Jul. 6, 2006

(54) Viscoelastic coating paste for protecting against macrofouling and method for producing a coating

(76) Inventor: Christof Baum, Dorum (DE)

Correspondence Address: LAW OFFICES OF KARL HORMANN, 86 SPARKS STREET, CAMBRIDGE, MA, 02138, US

(21) Appl. No.: 10/545,596

(22) PCT Filed: Feb. 12, 2004
(86) PCT No.: PCT/DE04/00299

§ 371 Date: Aug. 15, 2005

(30) Foreign Application Priority Data
Feb. 16, 2003 (DE) 103 07 762.6

(51) Int. Cl. C04B 9/02; C09D 5/18; C02F 5/10

(52) U.S. Cl. 106/18; 106/14.05; 252/180

(57) ABSTRACT

A non-toxic anti-fouling coating paste having a rheologic switching behavior based on a flow point, which can be set to the hydrodynamic and biological environmental conditions of a submarine component to be protected and which is between 5 Pa and 2,000 Pa above the wall shearing stress of the unfouled component to form a substrate which prevents colonization by marine fouling organisms.

### BACKGROUND OF THE INVENTION

1. Field of the Invention

The invention relates to a solvent-free and water-repellant visco-elastic polymeric coating paste as a habitation substrate for the temporary self-cleaning protection against natural macro-fouling on water-wetted components, and to a method of fabricating a coating as a habitation substrate by use of a solvent-free and water-repellant coating paste for the temporary self-cleaning protection against natural macro-fouling on water-wetted or submerged components, and, more particularly, to an apparatus for applying coating paste in accordance with the invention.

2. The Prior Art

It is a known problem that within a few days' time biofouling occurs on water-wetted components. In this connection, marine organisms such as, for instance, algae and barnacles, seek out marine surfaces for their habitation. Excessive habitation on nautical surfaces of the kind significant to man usually leads to the loss of their function and increased weight and friction. Increased friction, as a result of the enlarged surface, adversely affects the stability of the structure or the consumption of fuel needed for propelling such structure. In particular, added friction and weight destroy the physical control over measuring cables which stretch over many kilometers and which are utilized for geo-physical observations in connection with the prospecting for oil. Large quantities of barnacles prefer to attach themselves to such measuring cables (“seismic streamers”) and, more particularly, to angular connection points thereof. It is assumed that the slow movement of such cables at a depth of about 10 m and the turbulent current in the vicinity of the cable are preferred habitation sites of barnacles. As a result of such fouling, equipment may become damaged. Overgrown cables display poor signal-to-noise characteristics and thus provide data of poorer quality. For instance, barnacles generate a low-frequency background signal in the range of from 10 Hz to 70 Hz. To remove the growth or fouling from cables, barnacles are currently removed mechanically from the cables. This is sometimes carried out from small boats. Regular cleaning requires time, involves risks to operating crews and can only be carried out under appropriate weather conditions. By contrast, biofouling and barnacles are ubiquitous and perpetual. The degree of fouling and the exponential increase of the amount and mass of biofouling organisms in essence depend upon available food supplies and temperature. However, biofouling is also determined by the kind of the overgrown surface which is characterized by such decisive criteria as topography, wettability and visco-elasticity.

It is known in the art to use coatings of water-repellant properties for protecting water-wetted components from metal corrosion or rubber from becoming brittle. Water-repellant properties of anti-fouling coatings possess a lower adhesion tendency relative to organisms. Surfaces which are water-repellant have a lower surface tension relative to aqueous substances. Coatings of low surface tension have been used in the area of anti-fouling for more than twenty years. While their effective underlying mechanisms are not wholly understood, there are many experiment-derived indications to the effect that surfaces of both low surface tension and shearing stress render permanent habitation more difficult. Silicone, fluorocarbon and hydrocarbon resins, in particular, are known for their low surface tensions.

Hitherto, silicone oils, cross-linked silicone resins (see, for instance, DE 693 01 620 T2 describing a fouling-impeding silicone compound of silicone resin with a silicone fluid) or silicone particles in cross-linked resins (see, for instance, DE 196 35 824 A1 describing the use of cross-linked silicone elastomeric particles as a component of powdered lacquer compositions) have been used as protection against fouling. Technical Information by GE Research & Development Center (Technical Information Series, 97CRD062, May 1997, Class 1) report on the advantages of non-toxic anti-fouling coatings based on cross-linked silicone. The influence of fillers, cross-linking density and oil content in respect of the habitation of attachment behavior of barnacles was examined in particular. A highly cross-linked polysiloxane polymer was used the shear modulus of which was variable by way of fillers. It was found, in these data, that while on the one hand, fillers have no effect on the surface characteristics of the coatings, the shear modulus, on the other hand, does affect the fouling attachment. The findings were qualified by the statement that low shear Modula result in a greater fouling accumulation. However, there was no explanation for this behavior.

Permanently cross-linked silicone coatings are known as so-called “fouling release coatings” (see, for instance, U.S. Pat. No. 5,449,553 describing a dual-layer system of silicone resin or silicone particles in cross-linked resins). Like pure silicone oils, the chemically cross-linked silicone coatings do not in their dried state show changes in their behavior relative to changes in environmental conditions. Hence, the cleaning of such anti-fouling surfaces requires the heavy use of external mechanical means (water jet) or a rapid shearing movement during movement of a component through water. The shear forces to be generated for cleaning such surfaces are dependent upon the strength of adhesion of the biofouler which is usually in the range of the mechanical load capacity of the coating of 10⁵ Pa. Thus during cleaning, damage (cracks) frequently occurs to the coating. Moreover, such high shear forces are usually only attained by fast ships or rapidly moved components. Such anti-fouling coatings are not, therefore, sufficiently self-cleaning. In addition, temporary coatings based on waxes or silicone products are known for the protection of objects, in particular automobiles and ships. However, these coatings, too, have no flow point. Moreover, such compounds contain toxic materials and solvents. They are thus a burden on the environment, and they require hardening times for curing. The publication “Experience with Non-Fouling Coatings for Mussel Control” (A. C. Gross, Proc. Of the Fourth Intern. Zebra Mussel Conf., Madison, Wis., March 1994) compares the above-captioned oils and chemically cross-linked resins and, more particularly, soft silicone rubber paint as a foul-release coating with a silicone grease called “Slipstream” (no indications are given about the manufacturer, physical properties or disclosure of the contents). Compared to oil-containing and cross-linked silicones, the tested silicone grease is, however, ineffective. However, under varying ambient conditions (stronger or weaker current flow, more or less attached fouling organisms) none of the anti-fouling coatings mentioned in the publications indicate an optimum adaptation of their behavior. To date, no anti-fouling coatings of sufficient effectiveness have been achieved.

The publication “Penaten® to Control Zebra Mussel Attachment” (by J. A. Magee et al., downloadable under http://sgnis.org/publicat96_{—}19.htm as of 10 Jan. 2003) which forms the basis of the instant invention and which constitutes the closest prior art, describes, in the context of a test for their anti-fouling effectiveness, that as substrate-forming coating pastes, the solvent-free skin protection “Penaten®-Creme” (Johnson & Johnson Co., Hallein, Germany) and “Desitin®-Creme (Pfizer, Inc., New York, USA) yielded a low attachment rate for zebra mussels on a water-wetted component. The authors attributed the self-cleaning effect to the complex mixture of various hydrocarbons and medications, including zinc oxide (40% w/v). The authors also assumed a growth-impeding influence based on the hydrocarbons (hydrophobic petroleum jelly and petroleum distillates). However, no direct connection was established to the water-repellent and visco-elastic properties of the paste.

### OBJECTS OF THE INVENTION

The object of the invention is thus to improve a visco-elastic polymeric coating paste of the kind referred to such that it provides optimum anti-fouling properties as an attachment substrate for the temporary self-cleaning protection against natural macro-fouling on a water-wetted component. The anti-fouling properties are to be variable and greatly flexible in their application under given ambient conditions of the component to be protected. Moreover, the coating paste in accordance with the invention, to be simple and cost-efficient, is to be compounded of commercially available materials. Analogously, its manipulation is to provide for a method which allows application by simple and repeatable means. Furthermore, the coating paste in accordance with the invention is to be such that any fouling may be removed, without use of environmentally toxic substances, during operation of such means.

### SUMMARY OF THE INVENTION

In the accomplishment of these and other objects, the coating paste in accordance with the invention is characterized by a non-toxic composition having a flow point adjustable to the hydrodynamic and biological ambient conditions of the component and defining the transition between solid and liquid states. The flow point is to be between 5 PA and 2,000 Pa above the wall shearing stress of the protected component in its non-overgrown state. The adjustment of the flow point takes place selecting the composition of the paste and by the homogenous mixture thereof with shear-thickening and shear-thinning fillers. Advantageous embodiment of the invention are defined in the subclaims which are to be described in greater detail in connection with the invention.

As mentioned supra, biofouling is also determined by the properties of the growing surface which in its relevant criteria are characterized by its topography, wettability and visco-elasticity. The reason for the visco-elasticity of a coating affecting biofouling is not known. However, a comparison of biological surfaces with low growth reveals—as may be found in fish, dolphins and seaweeds—that their body surfaces form partially soft, partially highly elastic, aggregated, partially water-solvable or swellable, thermally reversible or chemically cross-linked mucilages (slimes) and gels. While the rheology (science of the deformation and flow of materials) of the biological body covering must satisfy more than one condition, many of those biological protective coatings have a flow point.

Targeted Theological examinations of the skin of dolphins for defining the visco-elasticity of the formed components have shown that biological systems, by the formation of gels, may achieve high levels of elasticity which are characterized by an elastic shear modulus or flow point in the range of up to 10,000 Pa. Above a critical load limit, the structure will be destroyed. This behavior is also known from polymers and mixtures of polymers. Since a physical principle for anti-fouling materials can be used only if the decisive Theological factor is known, tests were performed in the context of the present invention. Utilizing technical polymers as biomimetic materials, these tests showed that coatings of efficient protection against fouling must always have a flow point which, together with the viscosity, defines the visco-elasticity of the material. Moreover, fouling protection can only be achieved if the flow point of the coating is in the range of the wall shearing stress of the test surface. The knowledge of this made it possible to develop, as protection against fouling, an optimally effective coating paste adjustable to prevailing ambient conditions, on a flow-mechanical basis. By comparison to water as the wetting agent, the wettability of the coating paste is low. In sea water the paste is characterized by hydrophobia.

The coating paste in accordance with the invention mimics with technical materials the visco-elastic component of biological body coverings. In addition to its water-repellent property, the paste, in the sense of a technically applicable coating, is characterized in particular by a pronounced and characteristic flow point of its visco-elasticity. Thus, the coating paste in accordance with the invention, without making use of environmentally hazardous poisons or toxins, is in contrast to the requirements of macroscopic fouling organisms in respect of their attachment surfaces. The flow point defines the transition between the elastic behavior of the coating paste as a solid and the viscous behavior of the coating paste as a fluid as a function of the known wall shearing stress occurring on the surface of the component to be protected. The invention is thus based on a physical principle of fouling removal which is based upon the “Theological switching behavior” of the attachment substrate. The transition from the solid to the fluid state is the salient criterion for successfully removing macro-fouling. These material properties ensure that below its flow point the coating paste acts in the manner of a visco-elastic solid and adheres firmly to the structure. By low occurring mechanical stress (e.g. by the weight of attaching fouling organisms) the individually adjusted flow point of the coating paste is exceeded, however. The coating paste becomes more movable, loses its property as a supporting substrate and becomes inconsistent as regards its form. The mechanical stresses built up during this self-cleaning action are regenerated by the fouling organisms themselves as a result of their added friction and weight. The stresses are further increased by movement of the structure in the water. By contrast to known coatings based on silicone oils or cross-linked silicone polymers which have no defined flow point and, therefore, do not possess a controllable rheologic switching function (silicone oils always act as fluids, silicone polymers always act as solids), the rigidity of the applied unwetted coating paste in normal circumstances is related to the wall shearing stress. Thus, it is advantageous so to select the flow point of the coating paste that even a small increase in weight or shearing stress results in movement of the paste.

During its application the coating paste in accordance with the invention forms a smooth surface and is self-smoothing at shearing stresses above its flow point. Thus, its good self-cleaning properties notwithstanding, friction relative to the structure to be protected is reduced when no fouling is present on it and if it is moved. If the structure is fouled, the coating paste constitutes a loss layer. The durability of the attachment substrate formed by the coating paste may, if required, be individually set for days or months and depends upon the mechanical stress of the substrate. For geophysical applications, the durability may be set, for instance, for two months. Thus, the present invention make possible a coating, for instance, which protects salt water wetted surfaces from natural fouling. In this manner, the permanent attachment of such organisms as barnacles on hydrophone cables, oil platform supports and the hulls of ships may be prevented effectively and efficiently. For the first time, it has become possible to protect slow ships and slowly moving components (e.g. measuring cables) from detrimental fouling by the low firmness coating paste in accordance with the invention.

The coating paste in accordance with the invention is characterized by a characteristic and pronounced flow point. Many of the pastes known to the prior art also have a flow point. However, the known pastes are used as sealing compounds against intruding or extruding aqueous or gaseous media (e.g. the vacuum grease by Dow Corning Co.). Owing to their stiffness, such pastes stay in the gaps between structural components of ground glass, for instance, and ensure a pressure-tight closure as regards an exchange of material between the internal and external environments. Temperature-constant silicone pastes are used as friction-reducing agents and as lubrication between moving components. The fluidity of pastes generally makes possible the distribution of material between moving parts. In the nautical area as well, pastes are used as lubricants and as sealants (such as, for instance, “Orca Grease” of Henleys Propellers & Marine Ltd., Glenfield, New Zealand; pamphlet downloadable, as of 10 Jan. 2003, under http://www.henleyspropellers.com/orca_grease.htm). In contrast to the coating paste in accordance with the invention, the rheology of the known paste is set exclusively for lubricating and sealing, rather than as coating pastes for forming an attachment substrate against natural macro-fouling.

The flow point of the coating paste in accordance with the invention is characterized by being adjustable on the basis of hydrodynamic and biological environmental conditions of the component, which flow point is between 5 Pa up to 2,000 Pa above the wall shearing stress of the unfouled component to be protected. A setting slightly above the unstressed wall shearing stress ensures that while in its unfouled state providing a solid surface, the coating paste, by fluidization, nevertheless prevents an attachment of marine organisms of macroscopic size. High seas tests have shown the prevalence of such macro-organisms which in accordance with a further embodiment of the invention require a setting of the flow point which is 5 Pa to 200 Pa above the wall shearing stress of the unfouled component to be protected. The coating paste aims at shearing off any attaching fouling organisms. The coating is thus to act in the manner of a loss layer. However, in order to prevent loss of the coating under current conditions of higher wall shearing stresses, e.g. from large underwater structures which are subject to larger fluctuations, or at rough seas in general, coating pastes of higher flow points up to 2,000 Pa may also be applied. An attachment of fouling organisms under more difficult ambient conditions of this kind may thus be prevented by the coating paste in accordance with the invention. Moreover, the composition of the coating paste in accordance with the invention may advantageously be characterized by silicone, fluorocarbon or hydrocarbon as its main ingredient. Either substance is non-toxic and has properties suited to its application. While polymeric pastes including fluorocarbons are not, however, readily commercially available, silicone pastes may be obtained readily and at low cost. They are chemically inert. They are not absorbed and do not detrimentally interact with vital biological processes. In particular, silicones are not subject to rapid degradation by fungi and, therefore, provide extended protective action. They require added anti-bacterially effective zinc oxide, and the environment is protected. The individual setting of the flow point is selected on the basis of the composition of the paste (liquid oil or solid paste) and by homogeneous mixing with shear thickening and shear thinning additives. Silicone oil in particular constitutes an advantageous liquid composition base. By adding shear thickening or shear thinning additives such oil may be changed to a pasty state. The use of pure silicone oil leads to relatively high material losses so that the duration of protection is reduced. However, silicone oils may be changed to coating pastes of suitable flow points by the addition of shear thickening particles and pastes. Moreover, hydrocarbons may be used as the main component. Petroleum jelly which forms the base of Vaseline is particularly suitable. Hydrocarbons are nontoxic and can be removed more easily than silicones.

In the case of a liquid composition base, the individual setting of the flow point may be advantageously accomplished, in accordance with a further embodiment of the invention, by mixing with silica, metal or metal oxide particles, or with particles or fibers of biological components, such as, for instance, cellulose particles or fibers, as shear thickening additives. There is no limit to the contents of shear thickening material; it is a function of the flow point level which lies but slightly above the wall shearing stress of the component to be protected. There also are no limits regarding shape and size of the shear thickening materials. They simply depend upon the size of the fouling organisms. Individual compositions are set forth in the specific section of the specification.

In accordance with a further embodiment of the invention, shape-imparting particles may be added to the inventive coating paste. Such addition would result in a topography which is both macroscopically and microscopically variable (adaptation, the case of a soft consistency, to the contour of the substrate). The surface of the paste may be roughened by the addition of shape-imparting particles. The addition of fillers aims at reducing the contact surfaces between the bio-foulers and the surface to be protected. Preferably, the fillers are homogeneously distributed in the paste by mechanical mixing. It is known that low degrees of roughness in the nano-range are particularly suited for preventing algae and bacteria from settling on nautical products. Such hydrodynamic surfaces may be produced by adding structure-imparting nano and micro particles to conventional binders (see DE 101 17 945 A1). The silicone based coating paste described in the context of the invention is suitable for such a mixture, since only a single additional homogenizing step is required for the mixing. Overall, under stress the coating paste is of irregular shape, water repellent and soft. Such properties of the paste are, therefore, the opposite of those of attachment substrates preferred by many marine organisms, in particular barnacles. Thus, the coating paste in accordance with the invention achieves an optimum efficiency as regards the prevention of bio-fouling of underwater surfaces. For generating a hydrodynamic surface it is advantageous, in accordance with a further embodiment of the invention, to select a coating thickness which takes into consideration the height of the surface roughness and the mechanical stress of the component to be coated, the life expectancy of the coating and/or fouling pressure. Hence, the self-smoothing coating may be used to compensate for surface roughness. Since under stress the coating is one which will be used up, the life expectancy of the coating may be selected by its thickness. Preferably, the coating thickness may be from about 0.02 mm and 5 mm. The coating is effective on solid and flexible substrates and operates in a temperature range between −20° C. and 400° C.

The soft coating paste in accordance with the invention will change its shape on flexible substrates (e.g. moving measuring cables) and may thus be applied in an optimum manner. As an attachment substrate the coating is easy to fabricate and to roughen and it may, if needed, easily be removed mechanically or chemically. The process is cost-efficient and may be practiced by unskilled persons. Its contact with humans is harmless and constitutes no risk to the marine environment. The coating paste contains no solvents and itself is not flammable. Once it is applied, the coating is immediately ready for use. There is no waiting period to accommodate evaporation of solvents or cross-linking processes. The use of the paste in accordance with the invention at sea is safe and uncomplicated and is thus advantageous. A preferred method of making a solvent-free and water repellent coating, especially of an embodiment of the kind previously described, as an attachment substrate for the temporary self-cleaning protection against natural macro-fouling on a water-wetted component, by means of a coating apparatus for applying the coating paste is characterized by a first coating process of polishing or spraying the coating paste onto the component to be protected in a dry and clean condition and, if necessary, by further or renewed coating processes below water of the previously coated component. Spreading may be carried out with polishing cloths or brushes. A coating apparatus with sliding, vibrating or rotating elements, or a combination thereof, is particularly advantageous. To avoid repetitions reference may be had to specific sections of the specification for further details. An advantage of the coating paste with a flow point is that renewed applications of the paste are possible. This is not the case with existing foul-release coatings. It is also an advantage relative to permanent coatings that the paste may be removed from a component by means of mechanical forces greater than the flow point, or by using surfactants or soaps. Since the paste constitutes a consuming paste only in case of fouling, excess material may be recovered upon termination of the deployment, thus making material recycling possible. Such advantages are not offered by silicone oils and cross-linked resins.

### DESCRIPTION OF THE SEVERAL DRAWINGS

The novel features which are considered to be characteristic of the invention are set forth with particularity in the appended claims. The invention itself, however, in respect of its structure, construction and lay-out as well as its manufacturing techniques, together with other advantages and objects thereof, will be best understood from the following description of preferred embodiments when read in connection with the appended drawings, in which:

FIG. 1 shows a measuring cable fouled by barnacles;

FIG. 2 . . . 5 depicts the stress properties of different silicone based coating pastes;

FIG. 6 shows a measuring cable provided with the coating paste;

FIG. 7 depicts the mechanical spectrum of a silicone based coating paste; and

FIG. 8 shows a coating apparatus.

### DETAILED DESCRIPTION OF THE PREFERRED EMBODIMENTS

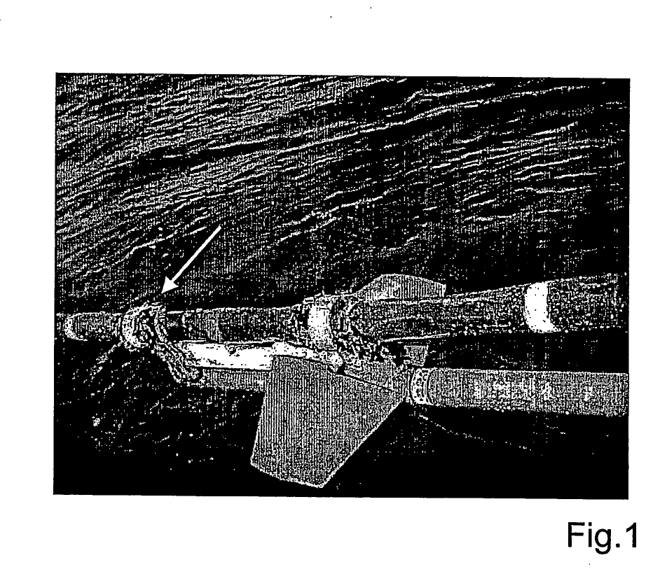

FIG. 1 is a photograph of an untreated measuring cable (streamer) for exploration purposes. It may be clearly seen, that the fastening sleeves (arrow) are fouled by barnacles.

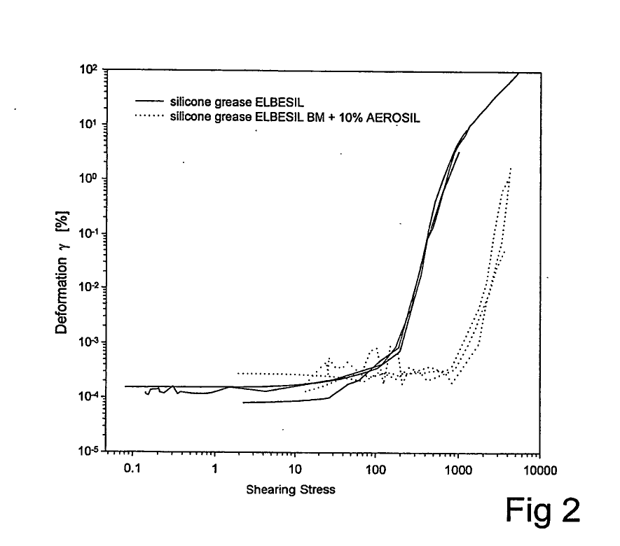

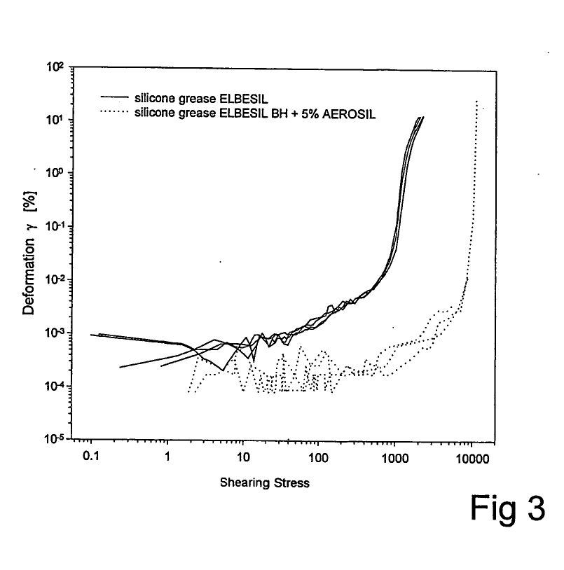

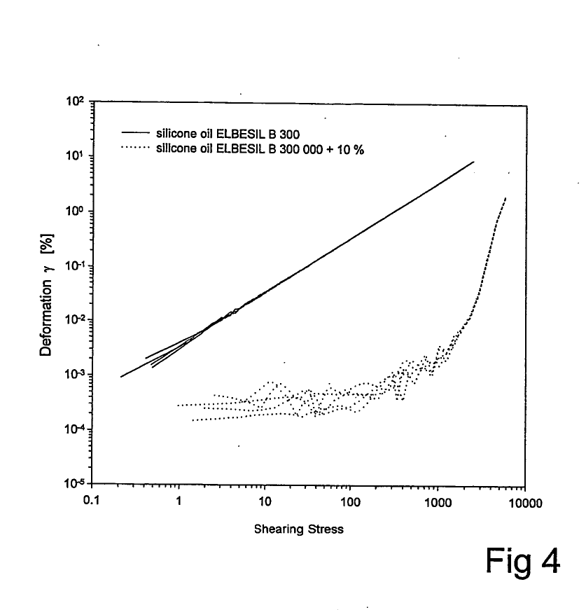

A coating made with a coating paste in accordance with the invention is characterized by a flow point (FIGS. 2 to 5). The flow point of the coating pastes is slightly higher than the wall shearing stress (5 Pa to 2,000 Pa, preferably 5 Pa to 200 Pa) affecting the unfouled component. The flow point is lower, however, than the wall shearing stress affecting the fouled component. The diagrams of FIGS. 2 to 5 disclose the stress properties of different coating pastes on a silicone base in accordance with the invention on a double logarithmic scale. They show the deformation γ [%] over the shearing stress τ [Pa]. The curves were recorded with a voltage-controlled rheometer (Haake RS 150, cone surface geometry, cone diameter 35 mm, opening angle 1°, measuring temperature T=20° C.). The flow point of each tested coating paste is shown as a break in the measuring curve. Below the flow point, the coating paste acts like a visco-elastic solid; above the flow point it acts like a visco-elastic fluid.

A mixture of a soft silicone paste (Elbesil BM, Boewing Company, Germany) containing 10% (w/w) of hydrophobic silicone nano particles (12 nm particle size, Aerosil R974, Degussa Company, Germany) resulted in a marked increase of the flow point (FIG. 2). The same result was obtained with a mixture of a firmer silicone paste (Elbesil BH, Boewing Company, Germany) including 5% (w/w) of hydrophilic silica nano particles (12 nm particle size, Aerosil 200, Degussa Company, Germany) (FIG. 3).

By contrast to the pure coating pastes, pure silicone oil (Elbesil B 300 000, Boewing Company, Germany) has no flow point (FIG. 4, top). It was, however, possible tp induce a flow point by admixing 10% (w/w) hydrophilic nano particles (12 nm particle size, Aerosil 200. Degussa Company, Germany) to the silicone oil (FIG. 4 bottom).

A mixture of the soft silicone paste (Elbesil BM, Boewing Company, Germany) and nano-porous cellulose micro particles (nominal pore size 100-=300 nm, particle size 20 μm, Fluka Company, Germany) showed a change in the flow point as a function of the concentration of the additives (FIG. 5). An admixture of 35% filler resulted in an increase in the flow point by three orders of magnitude, in contrast to a mixture including 10% filler or a paste without filler. The mixture including 35% filler had a rough surface.

The executed rheologic characterizations of silicone oils and silicone pastes with Theologically effective additives show that by admixing particulate additives, flow points may be attained in the range between 200 Pa and 7,000 Pa. It is thus possible in a targeted manner to establish a rheological switching behavior in a coating paste in accordance with the invention.

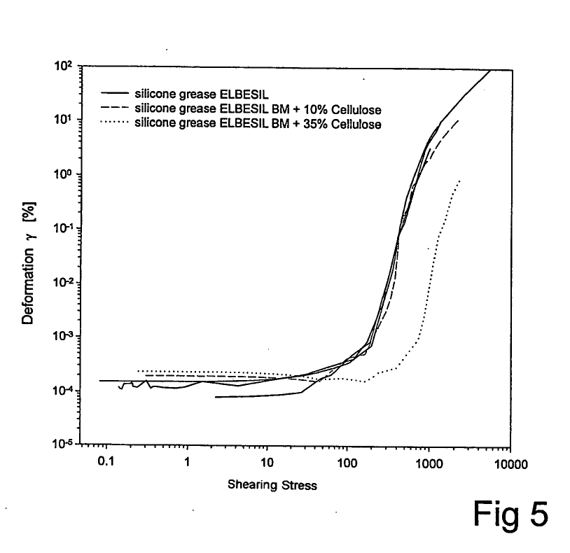

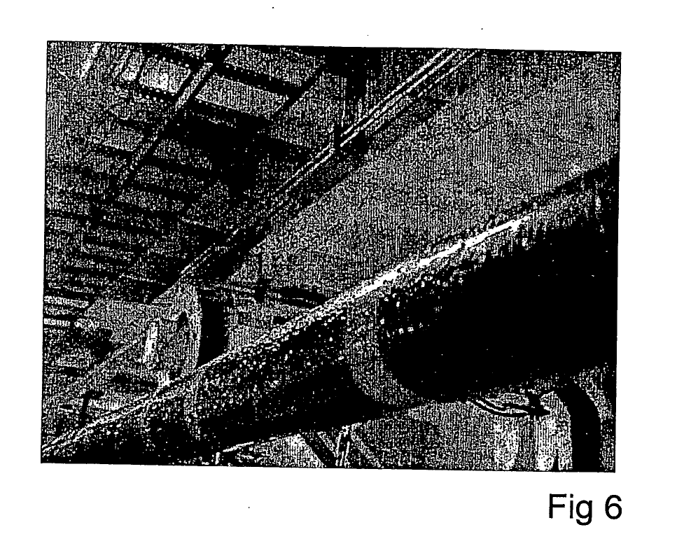

FIG. 6 depicts the appearance of the surface of a streamer cable coated with silicone paste in accordance with the invention after three weeks of testing. A thin layer of silicone paste (0.2 to 1 mm thickness) was polished onto the surface. As a result of the water-repellent (hydrophobic) properties of the coating the drops of salt water take on the appearance of small pearls. Fouling is no longer recognizable.

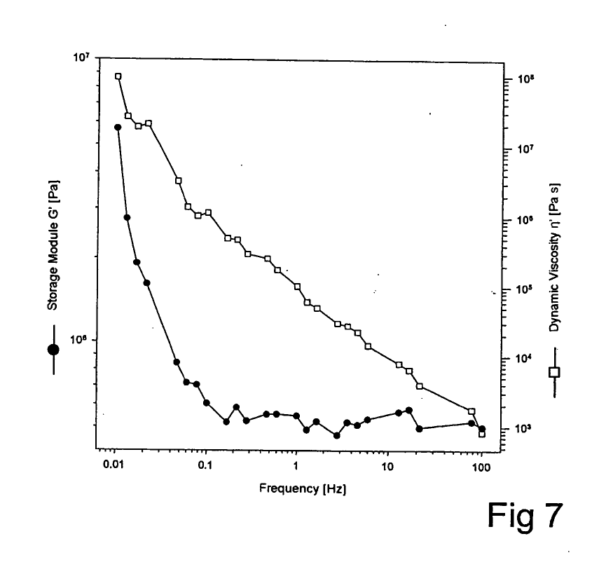

FIG. 7 depicts the mechanical spectrum of a soft silicone paste (Elbesil BM, Boewing Company, Germany) after frequency sweep of increasing frequency of 0.01 to 100 Hz (shearing stress 15 Pa, temperature 20° C.). The exponential non-linear drop of the storage modulus G′ with dropping frequency correlated to the flow point characteristic of the deformation curves (FIGS. 2 to 5). The drop in dynamic viscosity η′, however, was substantially linear. The absence of a non-linear viscosity curve proves that the measurements were executed in the linearly visco-elastic range. Furthermore, the curves show that an internal induced movement leads to an increase in the fluidity. The behavior may be used during preparation of the coating to achieve a smoothness of the surface by rapid oscillatory movement (e.g. vibration) and to reduce the silicone layers. In this connection, the thickness of the coating is determined by the roughness of the surface to be coated and it should complement the irregularities thereof. If, for instance, the surface of a streamer cable has a lateral roughness of 20 μm to 50 μm, the coating preferably is to be of a thickness of 50 μm. Other coating thicknesses are possible for the choice of coating thickness is a matter of the longevity of the coating which upon fouling acts as a surface to be consumed, as well as of the frequency of the mechanical displacement and of the fouling pressure.

In addition to silicone, for instance siloxane, fluoro or hydrocarbon, for instance petroleum jelly, may be used as the main component as well. Several examples of compositions and the flow points attainable as a function of temperature will be set forth hereafter. In real applications, the composition appropriate for the desired flow point may be selected with reference to the tables.

A) Pastes with Polymeric Siloxane

| | | Flow Point (Pa) at | | | |
|---|---|---|---|---|---|
| | | Sea Water Temperature (° C.) | | | |
| Composition | 5 | 10 | 20 | 30 | 45 |
| AK 100 + 5% H18 | 120 | 120 | 120 | 120 | 120 |
| AK 100 + 5% H20 RC | 90 | 90 | 90 | 90 | 90 |
| AK 300 + 10% HKSC | 200 | 200 | 200 | 200 | 200 |
| AK 300 + 15% HKSC | 450 | 450 | 450 | 450 | 450 |

The following ingredients were used in the compositions:

AK 100/300—polydimethylsiloxane oil (Wacker Co.)

Elbesil BM/BH—silicone pastes (Boewing Co.)

B) Pastes with Polymeric Hydrocarbon

| | | Flow Point (Pa) at | | | |
|---|---|---|---|---|---|
| | | Sea Water Temperature (° C.) | | | |
| Composition | 5 | 10 | 20 | 30 | 45 |
| Petroleum Jelly | 110 | 90 | 15 | none | none |
| Petroleum Jelly + Aerosil 200 | | | 32 | | |
| Petroleum Jelly + 5% H18 | | | 30 | | |
| Petroleum Jelly + 5% HKSC | | | 110 | | |
| Petroleum Jelly + 15% H18 | 900 | 750 | 300 | 30 | |
| Petroleum Jelly + 15 HKSC | 600 | 450 | 250 | 90 | |
| Petroleum Jelly + 20% HKSC | 1000 | 900 | 250 | 90 | |
| PWax Paste | | 1900 | 700 | 210 | 70 |

The following ingredient were used in the compositions:

| | | |
|---|---|---|
| 20.0 | parts | white petroleum jelly, medical grade DAB 8 (Riedel |
| | | de Haen Co.) |
| 1.35 | parts | white bees' wax, medical grade |
| 1.50 | parts | polydimethylsiloxane-linked silica nano particles |
| | | H18 (Wacker Co.) |
| .50 | parts | alkyd-linked silica nano particles (Wacker Co.) |
| .50 | parts | alkyd-linked silica nano particles (Wacker Co.) |
| 1.00 | part | titanium dioxide nano particles in simethic, |
| | | anatasic form Eusolex T (Merck Co.) |

The individual components are heated to a temperature of 80° C., mixed and stirred by a stator-rotor-mixer (Symex).

Silicone oils and silicone bees' waxes can be used in such pastes with hydrocarbons, such as, for instance, Pwax paste, in order to reduce the temperature dependency of the flow point. The use of silicone bees' waxes represents a simple method of incorporating silicones into the Pwax paste. This results in a stability of high certainty and lowered blooming of the silicone oils. Furthermore, such composition is noncritical to human skin, though more difficult to biologically to decompose compared to a paste not containing silicone.

Coating of a water-wetted surface with the silicone paste may be carried out by polishing or spraying. In case the paste is polished on, sliding, rotating or vibrating movements are preferred since movements above the flow point render the coating paste more moveable. To facilitate its application, the paste may initially be mixed with a solvent which following application will quickly evaporate and which will not detrimentally effect the functioning of the past.

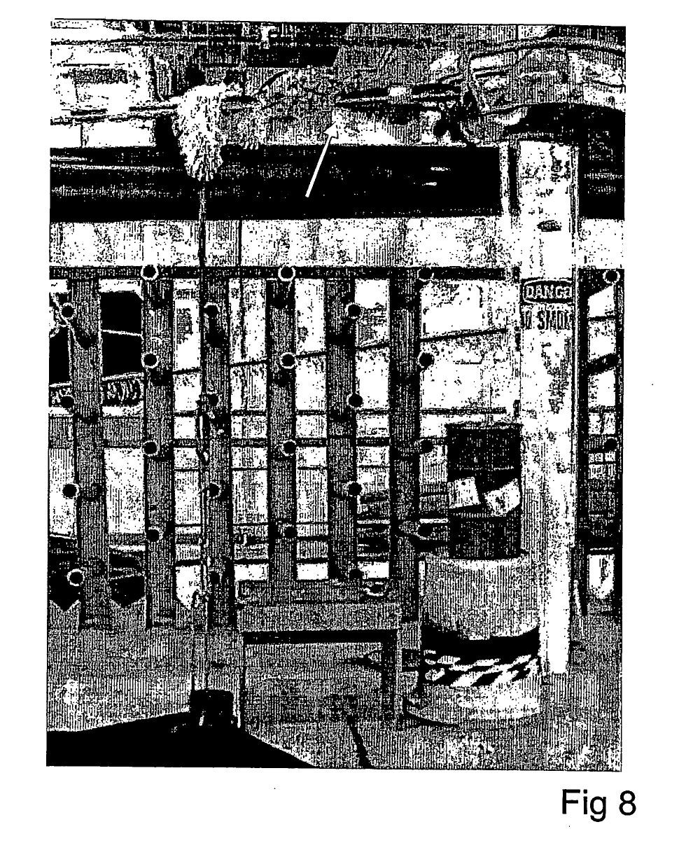

The prototype of an applicator is shown in FIG. 8. The shape of the brush shown (white arrow) is that of a four-stranded rope of Manila fibers wrapped 1.5 times around the measuring cable. For polishing, coating paste is applied between the wrapper and is coarsely distributed on the surface of the measuring cable so that, as the measuring cable is laid and pulled in again the paste is tightly pressed against the surface. One end of these brushes is attached to a fixed point whereas the other end of the brush is loaded with a weight. This arrangement makes it possible that the brush always engages the cable in a tight manner regardless of detents and elevations. The coating thickness attained is about 0.02 mm to 1 mm. The amount of coating paste required for a measuring cable of 6.4 cm diameter is about 5 kg of coating paste per 1 km length of cable. Other structures, such as a rotating ring brush are also possible. A clean and dry surface increases the efficiency of the first coating process. Repeated coatings may later be carried out under water, however, preferably on dry surfaces.

For the coating of appliances associated with the measuring cable, such as fastening sleeves and depth control units, the coating paste is applied or polished and distributed by a paint roller or by a cloth. The coated surfaces reject fouling of the equipment for about two months, whereby two or three winding and unwinding operations may be carried out during this time. If the coating has to be removed, removal is possible by mechanical treatment (e.g. by use of a high pressure cleaning apparatus).

What is claimed is:

1. A visco-elastic solvent-free and water-repellent polymeric coating paste for use as an attachment substrate for the temporary self-cleaning protection against natural macro fouling of a water-wetted component, characterized by a non-toxic compound adjustable in its flow point to the transition between a rigid and a liquid condition and to the hydrodynamic and biologically ambient conditions of the components, the flow point being 5 Pa to 2,000 Pa above the wall shearing stress of the protected component in the non-fouled state thereof, the adjustment of the flow point being performed by the selection of the basis of the compound of the paste and by the homogeneous admixture thereof with stress thickening or stress thinning fillers.

2. The coating paste of claim 1, characterized by a flow point 5 Pa to 200 Pa above the wall shearing stress of the protected component in its non-fouled state.

3. The coating paste of claim 1, wherein the main component of the non-toxic compound is selected from the group consisting of silicone, fluorocarbon or hydrocarbon.

4. The coating paste of claim 3, characterized by silicone oil as liquid basis of the compound.

5. The coating paste of claim 3, characterized by petroleum jelly as hydrocarbon.

6. The coating paste of one of claims 1, characterized by the admixture of silica, metal or metal oxide particles or particles or fibers of biological support components as shear-strengthening additive.

7. The coating paste of one of claims 1, characterized by the admixture of form-imparting particles.

8. The coating paste of one of claims 1, characterized by a coating thickness selected in accordance with the height of the surface roughness and the mechanical stress of the component to be coated, the intended life expectancy of the coating and/or the fouling pressure.

9. The coating paste of claim 7, characterized by a coating thickness between 0.02 mm and 5 mm.

10. A method of producing a coating as an attachment substrate by use of a visco-elastic solvent-free and water-repellent polymeric coating paste for the temporary self-cleaning protection against natural macro-growth on a water-wetted component in particular of one of claims 1 to 9 by means of a coating device for applying the coating paste, characterized by a first coating process by means of polishing or spraying of the coating paste onto the dry and clean component to be protected and, optionally, by additional or renewed coating processes of the pre-coated component under water.

11. The method of claim 10, characterized by a coating apparatus with sliding, vibrating or rotating elements or a combination thereof.
